(19) United States
(12) Patent Application Publication
(10) Pub. No.: US 2024/0084113 A1
(43) Pub. Date: Mar. 14, 2024

(54) RUBBER COMPOSITION AND PNEUMATIC TIRE USING THE SAME

(71) Applicant: Toyo Tire Corporation, Itami-shi (JP)

(72) Inventors: Souichiro Miura, Itami-shi (JP); Norio Minouchi, Itami-shi (JP)

(73) Assignee: Toyo Tire Corporation, Itami-shi (JP)

(21) Appl. No.: 18/227,634

(22) Filed: Jul. 28, 2023

(30) Foreign Application Priority Data
Aug. 26, 2022 (JP) 2022-134835

(51) Int. Cl. C08L 9/00; B60C 1/00; C08K 3/36; C08K 5/18; C08K 5/3437; C08K 5/47; C08L 7/00

(52) U.S. Cl. CPC C08L 9/00; B60C 1/0025; C08K 3/36; C08K 5/18; C08K 5/3437; C08K 5/47; C08L 7/00; C08K 2201/006; C08K 2201/019; C08L 2205/025; C08L 2205/03

(57) ABSTRACT

Provided are a rubber composition, which is capable of providing excellent low heat generation properties, aging resistance, and ozone resistance, and a pneumatic tire using the same.

The rubber composition includes a diene-based rubber, a filler, a phenylenediamine represented by the following formula (1) (wherein R₁ and R₂ are each an alkyl group or aryl group with 7 or more carbon atoms, provided that at least one of R₁ and R₂ is an alkyl group with 7 or more carbon atoms), a quinoline-based antioxidant, and N-cyclohexyl-2-benzothiazolylsulfenamide, in which silica is present in a proportion of 70 mass % or less based on the total filler amount, and the rubber composition is free of N-phenyl-N′-isopropyl-p-phenylenediamine (IPPD) and N-phenyl-N′-(1,3-dimethylbutyl)-p-phenylenediamine (6PPD).

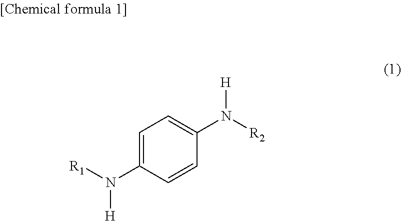

### BACKGROUND OF THE INVENTION

### 1. Field of the Invention

The present invention relates to a rubber composition and also to a pneumatic tire using the same.

### 2. Description of Related Art

In rubber compositions for use in tires, from the viewpoint of low heat generation properties, the incorporation of silica has been studied. In addition, in rubber compositions, from the viewpoint of aging resistance and ozone resistance, N-phenyl-N′-isopropyl-p-phenylenediamine (IPPD) or N-phenyl-N′-(1,3-dimethylbutyl)-p-phenylenediamine (6PPD) is generally used as an antioxidant. However, these compounds are highly adsorptive to the polar portion of silica, and there has been a risk that sufficient anti-aging effects may not be exhibited.

### SUMMARY OF THE INVENTION

In view of the above points, an object of an aspect of the invention is to provide a rubber composition capable of providing excellent low heat generation properties, aging resistance, and ozone resistance, and also a pneumatic tire using the same.

Incidentally, in JP2013-221052A, JP2013-95837A, JP2009-24134A, JPH10-324779A, and JP2021-91163A, there is no description of examples where a phenylenediamine having an alkyl group with 7 or more carbon atoms and a quinoline-based antioxidant are used together, and N-phenyl-N′-isopropyl-p-phenylenediamine (IPPD) and N-phenyl-N′-(1,3-dimethylbutyl)-p-phenylenediamine (6PPD) are not contained.

The invention encompasses the following embodiments.

[1] A rubber composition including a diene-based rubber, a filler, a phenylenediamine represented by the following formula (1), a quinoline-based antioxidant, and N-cyclohexyl-2-benzothiazolylsulfenamide, in which silica is present in a proportion of 70 mass % or less based on the total filler amount, and the rubber composition is free of N-phenyl-N′-isopropyl-p-phenylenediamine (IPPD) and N-phenyl-N′-(1,3-dimethylbutyl)-p-phenylenediamine (6PPD):

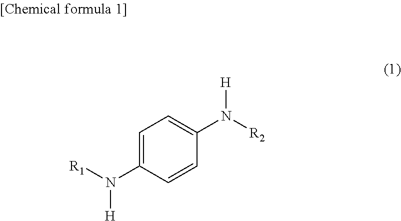

wherein R₁ and R₂ are each an alkyl group or aryl group with 7 or more carbon atoms, provided that at least one of R₁ and R₂ is an alkyl group with 7 or more carbon atoms.

[2] The rubber composition according to [1], in which the silica includes silica having a BET specific surface area of 50 to 250 m²/g.

[3] A pneumatic tire including the rubber composition according to [1] or [2] used in a sidewall thereof.

According to a rubber composition of an aspect of the invention, excellent low heat generation properties, aging resistance, and ozone resistance can be obtained.

### DESCRIPTION OF EMBODIMENTS

Hereinafter, matters relevant to the practice of the invention will be described in detail.

A rubber composition according to this embodiment includes a diene-based rubber, a filler, a phenylenediamine represented by the following formula (1), a quinoline-based antioxidant, and N-cyclohexyl-2-benzothiazolylsulfenamide, in which silica is present in a proportion of 70 mass % or less based on the total filler amount, and the rubber composition is free of N-phenyl-N′-isopropyl-p-phenylenediamine (IPPD) and N-phenyl-N′-(1,3-dimethylbutyl)-p-phenylenediamine (6PPD):

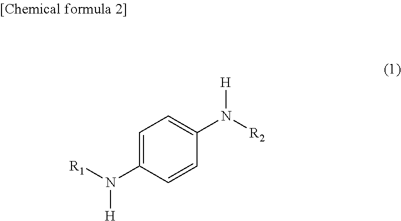

wherein R₁ and R₂ are each an alkyl group or aryl group with 7 or more carbon atoms, provided that at least one of R₁ and R₂ is an alkyl group with 7 or more carbon atoms.

As diene-based rubbers, for example, natural rubbers (NR), isoprene rubbers (IR), butadiene rubbers (BR), styrene butadiene rubbers (SBR), nitrile rubbers (NBR), chloroprene rubbers (CR), butyl rubbers (IIR), styrene-isoprene copolymer rubbers, butadiene-isoprene copolymer rubbers, styrene-isoprene-butadiene copolymer rubbers, and the like can be mentioned. Among them, natural rubbers and butadiene rubbers are preferable, and it is more preferable to use a natural rubber and a butadiene rubber together. In addition, diene-based rubbers also include these rubbers as modified. As modified rubbers, for example, modified SBR and modified BR can be mentioned. A modified rubber can have a heteroatom-containing functional group. The functional group may be introduced at the terminal of the polymer chain or into the polymer chain, but is preferably introduced at the terminal. As functional groups, amino groups, alkoxyl groups, hydroxyl groups, carboxyl groups, epoxy groups, cyano groups, halogen groups, and the like can be mentioned. Among them, amino groups, alkoxyl groups, hydroxyl groups, and carboxyl groups are preferable. A modified rubber can have at least one of the illustrated functional groups. As amino groups, a primary amino group, a secondary amino group, a tertiary amino group, and the like can be mentioned. As alkoxyl groups, a methoxy group, an ethoxy group, a propoxy group, a butoxy group, and the like can be mentioned. The illustrated functional groups interact with silanol groups (Si—OH) of silica. Here, an interaction means chemical bonding or hydrogen bonding through a chemical reaction with silanol groups of silica, for example. The amount of modified rubber in 100 mass % of the diene-based rubber may be 10 mass % or more, 20 mass % or more, or 30 mass % or more, and may be 90 mass % or less, 80 mass % or less, or 70 mass % or less.

The rubber composition according to this embodiment contains a filler. Examples of fillers include carbon black and silica. As carbon black, known various species can be used. As silica, for example, wet silica such as wet-precipitated silica or wet-gelled silica may be used.

The BET specific surface area of silica is preferably 50 to 250 m²/g, and more preferably 70 to 220 m²/g. When the BET specific surface area is within the above range, excellent low heat generation properties are likely to be obtained. In addition, adsorption of antioxidants is also suppressed, and excellent aging resistance and ozone resistance are likely to be obtained. Here, the BET specific surface area is a value measured in accordance with the BET method described in JIS K6430.

The filler content is not particularly limited, and is, per 100 parts by mass of the diene-based rubber, preferably 10 to 90 parts by mass, and more preferably 30 to 70 parts by mass.

The carbon black content is, per 100 parts by mass of the diene-based rubber, preferably 5 to 80 parts by mass, and more preferably 15 to 50 parts by mass.

The silica content is, per 100 parts by mass of the diene-based rubber, preferably 1 to 50 parts by mass, and more preferably 5 to 40 parts by mass.

The phenylenediamine used in this embodiment is represented by formula (1). R₁ and R₂ in formula (1) are each an alkyl group or aryl group with 7 or more carbon atoms, provided that at least one of R₁ and R₂ is an alkyl group with 7 or more carbon atoms. It is preferable that R₁ and R₂ are each an alkyl group with 7 to 20 carbon atoms or a phenyl group, provided that at least one of R₁ and R₂ is an alkyl group with 7 to 20 carbon atoms.

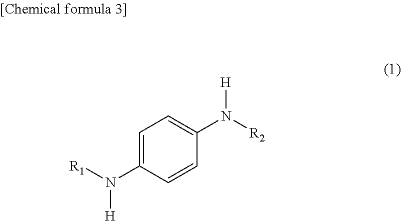

As such phenylenediamines, for example, N,N′-bis(1,4-dimethylpentyl)-p-phenylenediamine (77PD), N-phenyl-N′-(1-methylheptyl)-p-phenylenediamine (8PPD), N-phenyl-N′-(1,4-dimethylpentyl)-p-phenylenediamine (7PPD), and the like can be mentioned.

The phenylenediamine content is, per 100 parts by mass of the diene-based rubber, preferably 0.1 to 20 parts by mass, more preferably 0.5 to 15 parts by mass, still more 1 to 10 parts by mass, and particularly preferably 2 to 5 parts by mass.

As quinoline-based antioxidants, for example, 2,2,4-trimethyl-1,2-dihydroquinoline polymers (TMQ), poly(2,2,4-trimethyl-1,2-dihydroquinoline), 6-ethoxy-1,2-dihydro-2,2,4-trimethylquinoline (ETMQ), and the like can be mentioned.

The quinoline-based antioxidant content is, per 100 parts by mass of the diene-based rubber, preferably 0.1 to 20 parts by mass, more preferably 0.5 to 15 parts by mass, still more preferably 1 to 10 parts by mass, and particularly preferably 1 to 6 parts by mass.

The total antioxidant content (the total of the phenylenediamine and quinoline-based antioxidant described above) is, per 100 parts by mass of the diene-based rubber, preferably 1 to 20 parts by mass, more preferably 1 to 15 parts by mass, and still more preferably 1 to 10 parts by mass.

The content ratio between the phenylenediamine and the quinoline-based antioxidant is, on a mass basis, preferably 0.1 to 10, and more preferably 0.2 to 5.

A preferred example of the vulcanizing agents is sulfur. The vulcanizing agent content is not particularly limited, but is, per 100 parts by mass of the diene-based rubber, preferably 0.1 to 10 parts by mass, and more preferably 0.5 to 5 parts by mass.

In addition, as a vulcanization accelerator, N-cyclohexyl-2-benzothiazolylsulfenamide (CZ) is contained, and the content thereof is, per 100 parts by mass of the diene-based rubber, preferably 0.1 to 5 parts by mass, more preferably 0.1 to 3 parts by mass, and still more preferably 0.1 to 2 parts by mass. Vulcanization accelerators other than N-cyclohexyl-2-benzothiazolylsulfenamide (CZ) may also be contained as long as the effects of the invention are not impaired, but the content of N-tert-butyl-2-benzothiazolylsulfenamide (NS) is preferably less than 1 part by mass per 100 parts by mass of the diene-based rubber, more preferably not contained.

As a result of using N-cyclohexyl-2-benzothiazolylsulfenamide (CZ) as a vulcanization accelerator, as compared to N-tert-butyl-2-benzothiazolylsulfenamide (NS), excellent aging resistance can be obtained. Its mechanism is not clear, but is presumably as follows. Because the tert-butyl group of N-tert-butyl-2-benzothiazolylsulfenamide makes a stable carbocation and adsorbs to the polar portion of silica, or the benzothiazolylsulfenamide is highly electrophilic and adsorbs to the polar portion of silica, the effect as a vulcanization accelerator cannot be fully exhibited, and polysulfides are formed, adversely affecting aging resistance. Meanwhile, it can be assumed that in the case where N-cyclohexyl-2-benzothiazolylsulfenamide (CZ) is used, its adsorption to silica is lower as compared to N-tert-butyl-2-benzothiazolylsulfenamide (NS), and the effect as a vulcanization accelerator can be sufficiently exhibited.

The content ratio between silica and N-cyclohexyl-2-benzothiazolylsulfenamide (CZ) (silica/CZ) is, on a mass basis, preferably 1 to 80, and more preferably 5 to 40.

In addition to the above components, the rubber composition according to this embodiment can incorporate various additives generally used in rubber compositions, such as zinc oxide, stearic acid, antioxidants, waxes, oils, resins, and silane coupling agents.

Examples of oils include vegetable oils such as rapeseed oil and cottonseed oil, mineral oils such as paraffinic process oils, naphthenic process oils, and aromatic process oils, and plasticizers such as DOP and DBP. A suitable oil is selected in consideration of miscibility with the raw material rubber to be used. It is also possible to use two or more kinds of oils.

As resins, those having stickiness, that is, sticky resins are preferably used, and such a resin may be solid or liquid. As resins, for example, rosin-based resins, petroleum resins, coumarone-based resins, terpene-based resins, and the like can be mentioned. They may be used alone, and it is also possible to use two or more kinds together.

As rosin-based resins, for example, natural resin rosin and various rosin-modified resins using the same (e.g., rosin-modified maleic acid resin) can be mentioned.

As petroleum resins, aliphatic petroleum resins, aromatic petroleum resins, and aliphatic/aromatic copolymer petroleum resins can be mentioned. An aliphatic petroleum resin (also referred to as “C5-based petroleum resin”) is a resin obtained by cationically polymerizing an unsaturated monomer such as isoprene or cyclopentadiene, which is a petroleum fraction equivalent to 4 to 5 carbon atoms (C5 fraction), and may also be hydrogenated. An aromatic petroleum resin (also referred to as “C9-based petroleum resin”) is a resin obtained by cationically polymerizing a monomer such as vinyltoluene, an alkylstyrene, or indene, which is a petroleum fraction equivalent to 8 to 10 carbon atoms (C9 fraction), and may also be hydrogenated. An aliphatic/aromatic copolymer petroleum resin (also referred to as “C5/C9-based petroleum resin”) is a resin obtained by copolymerizing the C5 fraction and C9 fraction described above, and may also be hydrogenated.

A coumarone-based resin is a resin whose main component is coumarone, and, for example, coumarone resins, coumarone-indene resins, copolymer resins whose main components are coumarone, indene, and styrene, and the like can be mentioned.

As terpene-based resins, polyterpene, terpene-phenol resins, and the like can be mentioned.

The resin content is not particularly limited and may be, for example, per 100 parts by mass of the diene-based rubber, 1 to 30 parts by mass, 5 to 20 parts by mass, or 10 to 20 parts by mass.

In the rubber composition according to this embodiment, when silica is present as a filler, it is preferable to use a silane coupling agent together. The silane coupling agent content is preferably 2 to 20 mass %, more preferably 4 to 15 mass %, of the silica mass.

As silane coupling agents, for example, sulfide silanes such as bis(3-triethoxysilylpropyl)tetrasulfide, bis(3-triethoxysilylpropyl)disulfide, bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide, mercaptosilanes such as γ-mercaptopropyltrimethoxysilane, 7-mercaptopropyltriethoxysilane, mercaptopropylmethyldimethoxysilane, mercaptopropyldimethylmethoxysilane, and mercaptoethyltriethoxysilane, and protected mercaptosilanes such as 3-octanoylthio-1-propyltriethoxysilane and 3-propionylthiopropyltrimethoxysilane can be mentioned. One or any combination of them can be selected and used.

The rubber composition according to this embodiment can be prepared by kneading in the usual manner using a commonly used mixer, such as a Banbury mixer, a kneader, or a roll. That is, for example, in the first mixing stage, additives excluding a vulcanizing agent and a vulcanization accelerator are added to the diene-based rubber and mixed, and then, in the final mixing stage, a vulcanizing agent and a vulcanization accelerator are added to the obtained mixture and mixed, whereby a rubber composition can be prepared.

The pneumatic tire of the invention can be obtained by the vulcanization molding of a tire using the above rubber composition. The conditions for such tire vulcanization are not particularly limited, and vulcanization is usually performed at 140 to 180° C. for 10 to 30 minutes.

In the invention, the entirety of the rubber portion of a tire may be formed from the above rubber composition, but usually the rubber composition is partially used. That is, a rubber part made of the rubber composition is provided at least partially in the tread, sidewall, and bead. In that case, each of the tread, sidewall, and bead may be entirely or partially formed of the rubber part. In any case, it is preferable that the rubber part is provided on the tire surface side so as to be visible from the outside.

Preferably, the sidewall is entirely or partially formed of the rubber part.

### EXAMPLES

Hereinafter, examples of the invention will be shown, but the invention is not limited to these examples.

Using a lab mixer, following the formulations (parts by mass) shown in Tables 1 to 5 below, first, in the first mixing stage, ingredients excluding sulfur and a vulcanization accelerator were added to a diene-based rubber and kneaded (discharge temperature=160° C.). Next, in the final mixing stage, sulfur and a vulcanization accelerator were added to the obtained kneaded product and kneaded (discharge temperature=90° C.), thereby preparing a rubber composition. The details of the components in Tables 1 to 5 are as follows.
BR 1: “BR 150B” manufactured by Ube Industries, Ltd., cis content: 97%, glass transition temperature: −100° C.
BR 2: “Diene NF35R” manufactured by Asahi Kasei Corporation, cis content: 32%, glass transition temperature: −90° C.
BR 3: “BUNA-CB25” manufactured by LANXESS, cis content: 96%, glass transition temperature: −104° C.
BR 4: “VCR 617” manufactured by Ube Industries, Ltd., cis content: 98%, glass transition temperature: −100° C.
NR: RSS #3
Carbon black: “SEAST 3” manufactured by Tokai Carbon Co., Ltd.
Silica 1: “Nipsil AQ” manufactured by Tosoh Silica Corporation, BET specific surface area=205 m²/g
Silica 2: “ULTRASIL 4000 GR” manufactured by Evonik Industries AG, BET specific surface area=85 m²/g
Silane coupling agent: “Si69” manufactured by Evonik
Zinc oxide: “Type 1 Zinc Oxide” manufactured by Mitsui Mining & Smelting Co., Ltd.
Stearic acid: “LUNAC S-20” manufactured by Kao Corporation
Wax: “OZOACE 0355” manufactured by Nippon Seiro Co., Ltd.
Process oil: “PROCESS OIL NC140” manufactured by ENEOS Corporation
Amine-based antioxidant 1: “NOCRAC 810-NA” manufactured by Ouchi Shinko Chemical Industrial Co., Ltd., N-phenyl-N′-isopropyl-p-phenylenediamine (IPPD)
Amine-based antioxidant 2: “NOCRAC 6C” manufactured by Ouchi Shinko Chemical Industrial Co., Ltd., N-phenyl-N′-(1,3-dimethylbutyl)-p-phenylenediamine (6PPD)
Amine-based antioxidant 3: “Vulkanox 4030” manufactured by LANXESS, N,N′-BIS(1,4-dimethylpentyl)-p-phenylenediamine (77PD)
Amine-based antioxidant 4: “OZONONE 35” manufactured by Seiko Chemical Co., Ltd., N-phenyl-N′-(1-methylheptyl)-p-phenylenediamine (8PPD)
Amine-based antioxidant 5: “Santoflex 7PPD” manufactured by Eastman, N-phenyl-N′-(1,4-dimethylpentyl)-p-phenylenediamine (7PPD)
Quinoline-based antioxidant 1: “NOCRAC 224” manufactured by Ouchi Shinko Chemical Industrial Co., Ltd., 2,2,4-trimethyl-1,2-dihydroquinoline polymer (TMQ)
Quinoline-based antioxidant 2: “NOCRAC AW” manufactured by Ouchi Shinko Chemical Industrial Co., Ltd., 6-ethoxy-1,2-dihydro-2,2,4-trimethylquinoline (ETMQ)
Sulfur: “Powder Sulfur” manufactured by Tsurumi Chemical Industry Co., Ltd.
Vulcanization accelerator 1: “NOCCELER NS” manufactured by Ouchi Shinko Chemical Industrial Co., Ltd., N-tert-butyl-2-benzothiazolylsulfenamide
Vulcanization accelerator 2: “SOXINOL CZ” manufactured by Sumitomo Chemical Co., Ltd., N-cyclohexyl-2-benzothiazolylsulfenamide

Each obtained rubber composition was vulcanized at 160° C. for 20 minutes to prepare a test piece having a predetermined shape, and heat generation properties, aging resistance, and ozone resistance were evaluated. The evaluation methods are as follows.
Heat Generation Properties: Using a viscoelasticity tester manufactured by Toyo Seiki Co., Ltd., the loss coefficient tan 8 was measured at a frequency of 10 Hz, a static strain of 10%, a dynamic strain of 1%, and a temperature of 60° C., and its reciprocal was expressed as an index taking the value of the reference comparative example as 100. A larger index indicates better low heat generation properties (fuel efficiency).
Aging Resistance: The vulcanized rubber test piece was subjected to a tensile test in accordance with JIS K6251 to measure the breaking strength. Next, the vulcanized rubber test piece was heated in a gear oven temperature-controlled at 90° C. for 96 hours, and then similarly subjected to a tensile test to measure the breaking strength. The retention rate of the breaking strength after aging relative to the breaking strength before aging was determined, and expressed as an index taking the value of the reference comparative example as 100. The larger the index, the higher the retention rate, indicating better aging resistance.

Incidentally, in Table 1, Examples 1-1 to 1-3, Comparative Example 1-2, and Comparative Example 1-3 are based on Comparative Example 1-1. In Table 2, Examples 2-1 to 2-4 and Comparative Examples 2-2 to 2-5 are based on Comparative Example 2-1. In Table 3, Examples 3-1 to 3-4 and Comparative Examples 3-2 to 3-5 are based on Comparative Example 3-1. In Table 4, Examples 4-1 to 4-6 and Comparative Examples 4-2 to 4-4 are based on Comparative Example 4-1. In Table 5, Examples 5-1 to 5-7 and Comparative Examples 5-2 to 5-4 are based on Comparative Example 5-1.
Ozone Resistance: The test piece under the condition of 25% elongation was placed in an ozone weather meter device and left for 24 hours in an environment with an ozone concentration of 100 pphm and a temperature of 50° C. Subsequently, the state of crack generation was observed visually and under a 10× magnifying glass. The ozone resistance was evaluated on the following four-point scale.
4: No cracks generated
3: Cracks not visible to the naked eye but recognizable under a 10× magnifying glass generated
2: Cracks of 1 mm or less generated
1: Cracks exceeding 1 mm generated

TABLE 1

| | Comp. | Comp. | Comp. | | | |
|---|---|---|---|---|---|---|
| | Ex. 1-1 | Ex. 1-2 | Ex. 1-3 | Ex. 1-1 | Ex. 1-2 | Ex. 1-3 |
| BR 1 | 30 | 30 | 30 | 30 | 30 | 30 |
| BR 2 | 30 | 30 | 30 | 30 | 30 | 30 |
| NR | 40 | 40 | 40 | 40 | 40 | 40 |
| Carbon black | 35 | 30 | 30 | 30 | 30 | 30 |
| Silica 1 | — | 5 | 5 | 5 | 5 | 5 |
| Silane coupling agent | 1 | 1 | 1 | 1 | 1 | 1 |
| Zinc oxide | 3 | 3 | 3 | 3 | 3 | 3 |
| Stearic acid | 3 | 3 | 3 | 3 | 3 | 3 |
| Wax | 2 | 2 | 2 | 2 | 2 | 2 |
| Process oil | 20 | 20 | 20 | 20 | 20 | 20 |
| Amine-based antioxidant 2 | 3 | 3 | 3 | — | — | — |
| Amine-based antioxidant 3 | — | — | — | 3 | — | — |
| Amine-based antioxidant 4 | — | — | — | — | 3 | — |
| Amine-based antioxidant 5 | — | — | — | — | — | 3 |
| Quinoline-based antioxidant 1 | 2 | 2 | 2 | 3 | 3 | 3 |
| Sulfur | 2 | 2 | 2 | 2 | 2 | 2 |
| Vulcanization accelerator 1 | — | 1 | — | — | — | — |
| Vulcanization accelerator 2 | 1 | — | 1 | 1 | 1 | 1 |
| Silica proportion in total filler | — | 14 | 14 | 14 | 14 | 14 |
| (mass %) | | | | | | |
| Amine-based/quinoline-based | 1.5 | 1.5 | 1.5 | 1 | 1 | 1 |
| mass ratio | | | | | | |
| Heat generation properties | 100 | 105 | 105 | 106 | 106 | 106 |
| Aging resistance | 100 | 90 | 99 | 108 | 107 | 107 |
| Ozone resistance | 3 | 2 | 2 | 3 | 3 | 3 |

(Comp. Ex.: Comparative Example, Ex.: Example)

TABLE 2

| | Comp. | Comp. | Comp. | Comp. | Comp. | | | | |
|---|---|---|---|---|---|---|---|---|---|
| | Ex. 2-1 | Ex. 2-2 | Ex. 2-3 | Ex. 2-4 | Ex. 2-5 | Ex. 2-1 | Ex. 2-2 | Ex. 2-3 | Ex. 2-4 |
| BR 1 | 30 | 30 | 30 | 30 | 30 | 30 | 30 | 30 | 30 |
| BR 2 | 30 | 30 | 30 | 30 | 30 | 30 | 30 | 30 | 30 |
| NR | 40 | 40 | 40 | 40 | 40 | 40 | 40 | 40 | 40 |
| Carbon black | 70 | 50 | 50 | 50 | 50 | 50 | 50 | 50 | 50 |
| Silica 1 | — | 20 | 20 | 20 | 20 | 20 | 20 | 20 | 20 |
| Silane coupling agent | 1 | 2 | 2 | 2 | 2 | 2 | 2 | 2 | 2 |
| Zinc oxide | 3 | 3 | 3 | 3 | 3 | 3 | 3 | 3 | 3 |
| Stearic acid | 3 | 3 | 3 | 3 | 3 | 3 | 3 | 3 | 3 |
| Wax | 2 | 2 | 2 | 2 | 2 | 2 | 2 | 2 | 2 |
| Process oil | 20 | 20 | 20 | 20 | 20 | 20 | 20 | 20 | 20 |
| Amine-based antioxidant 1 | 3 | 3 | — | — | — | — | — | — | — |
| Amine-based antioxidant 2 | — | — | — | 2.5 | 2.5 | — | — | — | — |
| Amine-based antioxidant 3 | — | — | 4 | 2.5 | 2.5 | 2 | — | — | 2.5 |
| Amine-based antioxidant 4 | — | — | — | — | — | — | 2 | — | 2.5 |
| Amine-based antioxidant 5 | — | — | — | — | — | — | — | 2 | — |
| Quinoline-based antioxidant 1 | 2 | 2 | — | 1 | 1 | 2 | 2 | 2 | 1 |
| Sulfur | 2 | 2 | 2 | 2 | 2 | 2 | 2 | 2 | 2 |
| Vulcanization accelerator 1 | — | — | — | 1 | — | — | — | — | — |
| Vulcanization accelerator 2 | 1 | 1 | 1 | — | 1 | 1 | 1 | 1 | 1 |
| Silica proportion in total filler | — | 29 | 29 | 29 | 29 | 29 | 29 | 29 | 29 |
| (mass %) | | | | | | | | | |
| Amine-based/quinoline- | 1.5 | 1.5 | — | 5 | 5 | 1 | 1 | 1 | 5 |
| based mass ratio | | | | | | | | | |
| Heat generation properties | 100 | 109 | 110 | 109 | 109 | 109 | 109 | 110 | 111 |
| Aging resistance | 100 | 96 | 97 | 91 | 98 | 105 | 106 | 105 | 109 |
| Ozone resistance | 3 | 2 | 3 | 2 | 2 | 3 | 3 | 3 | 3 |

(Comp. Ex.: Comparative Example, Ex.: Example)

TABLE 3

| | Comp. | Comp. | Comp. | Comp. | Comp. | | | | |
|---|---|---|---|---|---|---|---|---|---|
| | Ex. 3-1 | Ex. 3-2 | Ex. 3-3 | Ex. 3-4 | Ex. 3-5 | Ex. 3-1 | Ex. 3-2 | Ex. 3-3 | Ex. 3-4 |
| BR 1 | 30 | 30 | 30 | 30 | 30 | 30 | 30 | 30 | 30 |
| BR 2 | 30 | 30 | 30 | 30 | 30 | 30 | 30 | 30 | 30 |
| NR | 40 | 40 | 40 | 40 | 40 | 40 | 40 | 40 | 40 |
| Carbon black | 40 | 25 | 25 | 25 | 25 | 25 | 25 | 25 | 25 |
| Silica 2 | — | 15 | 15 | 15 | 15 | 15 | 15 | 15 | 15 |
| Silane coupling agent | 1 | 1 | 1 | 1 | — | 1 | 1 | 1 | — |
| Zinc oxide | 3 | 3 | 3 | 3 | 3 | 3 | 3 | 3 | 3 |
| Stearic acid | 3 | 3 | 3 | 3 | 3 | 3 | 3 | 3 | 3 |
| Wax | 2 | 2 | 2 | 2 | 2 | 2 | 2 | 2 | 2 |
| Process oil | 20 | 20 | 20 | 20 | 20 | 20 | 20 | 20 | 20 |
| Amine-based antioxidant 2 | 2 | 2 | — | — | 2 | — | — | — | — |
| Amine-based antioxidant 3 | — | — | — | — | — | 3 | — | — | 2 |
| Amine-based antioxidant 4 | — | — | 3 | 3 | 2.5 | — | 3 | — | — |
| Amine-based antioxidant 5 | — | — | — | — | — | — | — | 3 | 2.5 |
| Quinoline-based antioxidant 1 | 4 | 4 | — | — | — | — | — | — | — |
| Quinoline-based antioxidant 2 | — | — | — | — | 1 | 2 | 3 | 3.5 | 1 |
| Sulfur | 2 | 2 | 2 | 2 | 2 | 2 | 2 | 2 | 2 |
| Vulcanization accelerator 1 | — | — | — | 1 | — | — | — | — | — |
| Vulcanization accelerator 2 | 1 | 1 | 1 | — | 1 | 1 | 1 | 1 | 1 |
| Silica proportion in total filler | — | 38 | 38 | 38 | 38 | 38 | 38 | 38 | 38 |
| (mass %) | | | | | | | | | |
| Amine-based/quinoline-based | 0.5 | 0.5 | — | — | 4.5 | 1.5 | 1 | 0.9 | 4.5 |
| mass ratio | | | | | | | | | |
| Heat generation properties | 100 | 110 | 110 | 110 | 110 | 111 | 112 | 111 | 112 |
| Aging resistance | 100 | 97 | 96 | 92 | 99 | 107 | 106 | 106 | 108 |
| Ozone resistance | 3 | 2 | 2 | 2 | 2 | 3 | 3 | 3 | 3 |

(Comp. Ex.: Comparative Example, Ex.: Example)

TABLE 4

| | Comp. | Comp. | Comp. | Comp. | | | | | | |
|---|---|---|---|---|---|---|---|---|---|---|
| | Ex. 4-1 | Ex. 4-2 | Ex. 4-3 | Ex. 4-4 | Ex. 4-1 | Ex. 4-2 | Ex. 4-3 | Ex. 4-4 | Ex. 4-5 | Ex. 4-6 |
| BR 1 | — | — | — | — | 30 | — | 30 | — | 30 | — |
| BR 2 | 30 | 30 | 30 | 30 | 30 | 30 | 30 | 30 | 30 | 30 |
| BR 3 | 30 | 30 | 30 | 30 | — | 30 | — | 30 | — | 30 |
| NR | 40 | 40 | 40 | 40 | 40 | 40 | 40 | 40 | 40 | 40 |
| Carbon black | 30 | 15 | 15 | 15 | 15 | 15 | 15 | 15 | 15 | 15 |
| Silica 1 | — | 15 | 15 | 15 | 15 | 15 | 15 | 15 | 15 | 15 |
| Silane coupling agent | 1 | — | — | — | — | 2 | — | 2 | — | 2 |
| Zinc oxide | 3 | 3 | 3 | 3 | 3 | 3 | 3 | 3 | 3 | 3 |
| Stearic acid | 3 | 3 | 3 | 3 | 3 | 3 | 3 | 3 | 3 | 3 |
| Wax | 2 | 2 | 2 | 2 | 2 | 2 | 2 | 2 | 2 | 2 |
| Process oil | 20 | 20 | 20 | 20 | 20 | 20 | 20 | 20 | 20 | 20 |
| Amine-based antioxidant 2 | 3 | 3 | 3 | — | — | — | — | — | — | — |
| Amine-based antioxidant 3 | — | — | — | — | 4 | 4 | — | — | — | — |
| Amine-based antioxidant 4 | — | — | — | — | — | — | 4 | 4 | — | — |
| Amine-based antioxidant 5 | — | — | — | 4 | — | — | — | — | 4 | 4 |
| Quinoline-based antioxidant 3 | 3 | 3 | 3 | — | 2 | 5 | 2 | 5 | 2 | 5 |
| Sulfur | 2 | 2 | 2 | 2 | 2 | 2 | 2 | 2 | 2 | 2 |
| Vulcanization accelerator 1 | — | 1 | — | — | — | — | — | — | — | — |
| Vulcanization accelerator 2 | 1 | — | 1 | 1 | 1 | 1 | 1 | 1 | 1 | 1 |
| Silica proportion in total filler | — | 50 | 50 | 50 | 50 | 50 | 50 | 50 | 50 | 50 |
| (mass %) | | | | | | | | | | |
| Amine-based/quinoline-based | 1 | 1 | 1 | — | 2 | 0.8 | 2 | 0.8 | 2 | 0.8 |
| mass ratio | | | | | | | | | | |
| Heat generation properties | 100 | 109 | 109 | 110 | 110 | 110 | 110 | 109 | 110 | 110 |
| Aging resistance | 100 | 91 | 97 | 100 | 108 | 109 | 108 | 108 | 107 | 108 |
| Ozone resistance | 3 | 2 | 2 | 2 | 3 | 3 | 3 | 3 | 3 | 3 |

(Comp. Ex.: Comparative Example, Ex.: Example)

TABLE 5

| | Comp. | Comp. | Comp. | Comp. | | | | | | | |
|---|---|---|---|---|---|---|---|---|---|---|---|
| | Ex. 5-1 | Ex. 5-2 | Ex. 5-3 | Ex. 5-4 | Ex. 5-1 | Ex. 5-2 | Ex. 5-3 | Ex. 5-4 | Ex. 5-5 | Ex. 5-6 | Ex. 5-7 |
| BR 1 | 30 | 30 | 30 | 30 | 30 | 30 | 30 | 30 | 30 | 30 | 30 |
| BR 2 | — | — | — | — | 30 | — | 30 | — | 30 | — | — |
| BR 4 | 30 | 30 | 30 | 30 | — | 30 | — | 30 | — | 30 | 30 |
| NR | 40 | 40 | 40 | 40 | 40 | 40 | 40 | 40 | 40 | 40 | 40 |
| Carbon black | 50 | 15 | 15 | 15 | 15 | 15 | 15 | 15 | 15 | 15 | 15 |
| Silica 2 | — | 35 | 35 | 35 | 35 | 35 | 35 | 35 | 35 | 35 | 35 |
| Silane coupling agent | 1 | 4 | 4 | 4 | 4 | 4 | 4 | 4 | 4 | 4 | 4 |
| Zinc oxide | 3 | 3 | 3 | 3 | 3 | 3 | 3 | 3 | 3 | 3 | 3 |
| Stearic acid | 3 | 3 | 3 | 3 | 3 | 3 | 3 | 3 | 3 | 3 | 3 |
| Wax | 2 | 2 | 2 | 2 | 2 | 2 | 2 | 2 | 2 | 2 | 2 |
| Process oil | 20 | 20 | 20 | 20 | 20 | 20 | 20 | 20 | 20 | 20 | 20 |
| Amine-based antioxidant 1 | — | — | 2.5 | 2.5 | — | — | — | — | — | — | — |
| Amine-based antioxidant 2 | 3 | 3 | — | — | — | — | — | — | — | — | — |
| Amine-based antioxidant 3 | — | — | — | — | 2.5 | 4 | — | — | — | — | — |
| Amine-based antioxidant 4 | — | — | — | — | — | — | 2.5 | 4 | — | — | 2 |
| Amine-based antioxidant 5 | — | — | 2 | 2 | — | — | — | — | 2.5 | 4 | 2 |
| Quinoline-based antioxidant 1 | — | — | 1.5 | 1.5 | 5 | — | 5 | — | 5 | — | 1.5 |
| Quinoline-based antioxidant 2 | 2 | 3 | — | — | — | 4 | — | 5 | — | 5 | — |
| Sulfur | 2 | 2 | 2 | 2 | 2 | 2 | 2 | 2 | 2 | 2 | 2 |
| Vulcanization accelerator 1 | — | — | 1 | — | — | — | — | — | — | — | — |
| Vulcanization accelerator 2 | 1 | 1 | — | 1 | 1 | 1 | 1 | 1 | 1 | 1 | 1 |
| Silica proportion in total filler | — | 70 | 70 | 70 | 70 | 70 | 70 | 70 | 70 | 70 | 70 |
| (mass %) | | | | | | | | | | | |
| Amine-based/quinoline- | 1.5 | 1 | 3 | 3 | 0.5 | 1 | 0.5 | 0.8 | 0.5 | 0.8 | 3 |
| based mass ratio | | | | | | | | | | | |
| Heat generation properties | 100 | 122 | 122 | 122 | 121 | 122 | 122 | 122 | 122 | 123 | 123 |
| Aging resistance | 100 | 93 | 90 | 96 | 106 | 109 | 106 | 108 | 105 | 107 | 108 |
| Ozone resistance | 3 | 2 | 2 | 2 | 3 | 3 | 3 | 3 | 3 | 3 | 3 |

(Comp. Ex.: Comparative Example, Ex.: Example)

As a result, as shown in Table 1, a comparison between Comparative Example 1-1 and Comparative Example 1-3 showed that the incorporation of silica improves low heat generation properties, but aging resistance and ozone resistance are deteriorated. In addition, a comparison between Comparative Example 1-2 and Comparative Example 1-3 showed that the aging resistance improves more when using N-cyclohexyl-2-benzothiazolylsulfenamide as a vulcanization accelerator than when using N-tert-butyl-2-benzothiazolylsulfenamide.

Meanwhile, in Examples 1-1 to 1-3, a predetermined phenylenediamine, a quinoline-based antioxidant, silica, and N-cyclohexyl-2-benzothiazolylsulfenamide were used together, and, as a result, it was possible to simultaneously achieve excellent low heat generation properties, aging resistance, and ozone resistance.

As shown in Table 2, a comparison between Comparative Example 2-1 and Comparative Example 2-2 showed that the incorporation of silica improves low heat generation properties, but aging resistance and ozone resistance are deteriorated. In addition, Comparative Example 2-3 is an example where a predetermined phenylenediamine was used alone as an antioxidant, and the ozone resistance was poor. Comparative Example 2-4 and Comparative Example 2-5 are examples where a phenylenediamine having an alkyl group with 6 or less carbon atoms, a predetermined phenylenediamine, and a quinoline-based antioxidant were used together, and the aging resistance and ozone resistance were poor.

Meanwhile, in Examples 2-1 to 2-4, a predetermined phenylenediamine, a quinoline-based antioxidant, silica, and N-cyclohexyl-2-benzothiazolylsulfenamide were used together, and, as a result, it was possible to simultaneously achieve excellent low heat generation properties, aging resistance, and ozone resistance.

As shown in Table 3, a comparison between Comparative Example 3-1 and Comparative Example 3-2 showed that the incorporation of silica improves low heat generation properties, but aging resistance and ozone resistance are deteriorated. In addition, Comparative Example 3-3 and Comparative Example 3-4 are examples where a predetermined phenylenediamine was used alone as an antioxidant, and the aging resistance and ozone resistance were poor. Comparative Example 3-5 is an example where a phenylenediamine having an alkyl group with 6 or less carbon atoms, a predetermined phenylenediamine, and a quinoline-based antioxidant were used together, and the aging resistance and ozone resistance were poor.

Meanwhile, in Examples 3-1 to 3-4, a predetermined phenylenediamine, a quinoline-based antioxidant, silica, and N-cyclohexyl-2-benzothiazolylsulfenamide were used together, and, as a result, it was possible to simultaneously achieve excellent low heat generation properties, aging resistance, and ozone resistance.

As shown in Table 4, a comparison among Comparative Example 4-1, Comparative Example 4-2, and Comparative Example 4-3 showed that the incorporation of silica improves low heat generation properties, but aging resistance and ozone resistance are deteriorated. In addition, Comparative Example 4-4 is an example where a predetermined phenylenediamine was used alone as an antioxidant. No improvement in aging resistance was seen, and the ozone resistance was poor.

Meanwhile, in Examples 4-1 to 4-6, a predetermined phenylenediamine, a quinoline-based antioxidant, silica, and N-cyclohexyl-2-benzothiazolylsulfenamide were used together, and, as a result, it was possible to simultaneously achieve excellent low heat generation properties, aging resistance, and ozone resistance.

As shown in Table 5, a comparison between Comparative Example 5-1 and Comparative Example 5-2 showed that the incorporation of silica improves low heat generation properties, but aging resistance and ozone resistance are deteriorated. In addition, Comparative Example 5-4 is an example where a phenylenediamine having an alkyl group with 6 or less carbon atoms, a predetermined phenylenediamine, and a quinoline-based antioxidant were used together, and the aging resistance and ozone resistance were poor.

Meanwhile, in Examples 5-1 to 5-7, a predetermined phenylenediamine, a quinoline-based antioxidant, silica, and N-cyclohexyl-2-benzothiazolylsulfenamide were used together, and, as a result, it was possible to simultaneously achieve excellent low heat generation properties, aging resistance, and ozone resistance.

The rubber composition of the invention can be used as a rubber composition for various tires for passenger cars, light trucks, buses, and the like.

1. A rubber composition comprising:
a diene-based rubber;
a filler;
a phenylenediamine represented by the following formula (1);
a quinoline-based antioxidant; and
N-cyclohexyl-2-benzothiazolylsulfenamide, wherein
silica is present in a proportion of 70 mass % or less based on the total filler amount, and
the rubber composition is free of N-phenyl-N′-isopropyl-p-phenylenediamine (IPPD) and N-phenyl-N′-(1,3-dimethylbutyl)-p-phenylenediamine (6PPD): 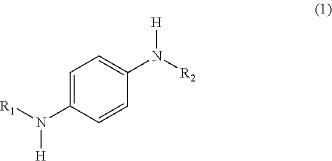
wherein R₁ and R₂ are each an alkyl group or aryl group with 7 or more carbon atoms, provided that at least one of R₁ and R₂ is an alkyl group with 7 or more carbon atoms.

2. The rubber composition according to claim 1, wherein the silica includes silica having a BET specific surface area of 50 to 250 m²/g.

3. A pneumatic tire comprising the rubber composition according to claim 1 used in a sidewall thereof.

4. A pneumatic tire comprising the rubber composition according to claim 2 used in a sidewall thereof.

5. A rubber composition comprising:
a diene-based rubber;
a filler;
a phenylenediamine represented by the following formula (1);
a quinoline-based antioxidant; and
N-cyclohexyl-2-benzothiazolylsulfenamide, wherein
silica is present in a proportion of 70 mass % or less based on the total filler amount, and
the rubber composition is free of N-phenyl-N′-isopropyl-p-phenylenediamine (IPPD) and N-phenyl-N′-(1,3-dimethylbutyl)-p-phenylenediamine (6PPD): 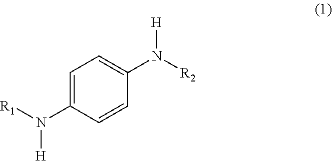
wherein R₁ and R₂ are each an alkyl group with 7 to 20 carbon atoms or phenyl group, provided that at least one of R₁ and R₂ is an alkyl group with 7 to 20 carbon atoms.

6. The rubber composition according to claim 5, wherein the silica includes silica having a BET specific surface area of 50 to 250 m²/g.

7. A pneumatic tire comprising the rubber composition according to claim 5 used in a sidewall thereof.

8. A pneumatic tire comprising the rubber composition according to claim 6 used in a sidewall thereof.

9. A rubber composition comprising:
a diene-based rubber;
a filler;
at least one phenylenediamine selected from the group consisting of N,N′-bis(1,4-dimethylpentyl)-p-phenylenediamine (77PD), N-phenyl-N′-(1-methylheptyl)-p-phenylenediamine (8PPD), and N-phenyl-N′-(1,4-dimethylpentyl)-p-phenylenediamine (7PPD);
a quinoline-based antioxidant; and
N-cyclohexyl-2-benzothiazolylsulfenamide, wherein
silica is present in a proportion of 70 mass % or less based on the total filler amount, and
the rubber composition is free of N-phenyl-N′-isopropyl-p-phenylenediamine (IPPD) and N-phenyl-N′-(1,3-dimethylbutyl)-p-phenylenediamine (6PPD).

10. The rubber composition according to claim 9, wherein the silica includes silica having a BET specific surface area of 50 to 250 m²/g.

11. A pneumatic tire comprising the rubber composition according to claim 9 used in a sidewall thereof.

12. A pneumatic tire comprising the rubber composition according to claim 10 used in a sidewall thereof.
